(19) United States
(12) Patent Application Publication
(10) Pub. No.: US 2001/0054392 A1
(43) Pub. Date: Dec. 27, 2001

(54) Implement for milking animals

(75) Inventors: Renatus Ignatius Josephus Fransen, Vlaardingen (NL); Jentje Deelstra, AA Rijswijk (NL)

Correspondence Address: Penrose Lucas Albright, Esq., MASON, MASON & ALBRIGHT, 2306 South Eads Street, P.O. Box 2246, Arlington, VA, 22202-0246, US

(73) Assignee: LELY RESEARCH HOLDING A.G. a Swiss limited liability Co.

(21) Appl. No.: 09/888,437

(22) Filed: Jun. 26, 2001

(30) Foreign Application Priority Data
Jun. 26, 2000 (NL) 1015525

(51) Int. Cl. A01J 3/00

(52) U.S. Cl. 119/14.08

(57) ABSTRACT

An implement for milking animals, such as cows, provided with a milking parlour with a milking robot for automatically attaching teat cups (1) to the teats of an animal to be milked, said implement further being provided with milk container means for the milk obtained, while in at least one milk line (2) between the teat cups (1) and the milk container means there is provided an auxiliary reservoir (7) in which a certain quantity of milk, substantially obtained at the beginning of the milking process, is collected via an inlet opening and can leave said auxiliary reservoir (7) via an outlet opening with shutting off means (9), while the milk obtained thereafter is substantially led to the milk container means. The inlet opening is provided with further shutting off means (13) which are at least suitable for preventing the milk collected in the auxiliary reservoir (7) from being discharged to the milk container means.

The present invention relates to an implement for milking animals, as described in the preamble of claim 1.

Such an implement is known from Dutch patent 1004196.

Upon milking animals in such an implement it is of importance that the foremilk is automatically separated from the further milk, as the foremilk is usually somewhat infected and/or of an other quality. According to the invention, this is achieved by the measures described in the characterizing part of claim 1. The implement according to the invention has the advantage that mixing of the foremilk collected with the milk that is led to the milk container means is prevented or at least minimized to a considerable extent. When the foremilk from each of the udder quarters has to be collected, while the milk flow from the individual udder quarters does not start simultaneously, e.g. because the teat cups are attached consecutively to the teats, it is of importance that there is provided an auxiliary reservoir in each of the milk lines between a teat cup and the milk container means. For the purpose of adequately separating the foremilk from the milk obtained thereafter, the content of the auxiliary reservoir will have to be larger than the to be expected quantity of foremilk. Preferably the content of the auxiliary reservoir is approximately two to three times as large as the to be expected quantity of foremilk.

In a particular embodiment, only at the beginning of the milking process the auxiliary reservoir is in open connection with the relevant milk line between a teat cup and the milk container means. As a result thereof the first milk obtained will automatically fill the auxiliary reservoir and, when the latter is completely filled, the subsequent milk flow will be led to the milk container means. In a concrete embodiment, in the relevant milk line there is included a connecting element to which the interrupted ends of the milk line are connected, the lower side of said connecting element being provided with an aperture to which the auxiliary reservoir is connected. In order to prevent foremilk from flowing beyond said aperture to the milk container means, the two ends of the milk line are connected to the connecting element in a substantially horizontal plane, in a staggered position opposite each other. In this way the connecting element forms a resistance ensuring that the first milk, so including the foremilk, arrives in the auxiliary reservoir and, only when the latter is completely filled, the milk obtained thereafter can flow to the milk container means.

For the purpose of discharging the milk collected in the auxiliary reservoir, according to the invention the shutting off means comprise an outlet valve that shuts off the auxiliary reservoir by means of the vacuum present in the milk line. Said outlet valve releases the outflow opening of the auxiliary reservoir when after milking the teat cup comes in open connection with the outside air, or when the teat cup is included in a rinsing line system for only cleaning the teat cup or when the teat cup is included in a rinsing line system and rinsing of the teat cup and the milk line system connected thereto is ended. In other words, as soon as an animal has been milked out and a relevant teat cup is detached, the vacuum in said teat cup and the milk line connected thereto is removed and the outlet valve of the relevant auxiliary reservoir is released, so that the milk present in the auxiliary reservoir can flow away. However, also when the teat cups and, if desired, the milk line system have to be cleaned and a rinsing liquid is brought into the teat cup and the milk line connected thereto in the usual way by means of a rinsing member that is attached to a teat cup, because of the fact that the auxiliary reservoir is then being filled with rinsing liquid, said rinsing liquid will have to be discharged, i.e. as soon as the teat cup is detached from the rinsing members According to a further inventive feature, the outlet valve is constituted by a first ball. Such an outlet valve has the advantage of being less sensitive to contamination. According to another inventive feature, the further shutting off means of the inlet opening of the auxiliary reservoir comprise an inlet valve which is designed as a float. When the auxiliary reservoir is filled with the foremilk, the float continues to float on the milk and shuts off the inlet opening when the auxiliary reservoir is completely filled with foremilk. In a preferred embodiment of the invention the float is also designed as a ball. To facilitate mounting of the balls in the foremilking implement the diameter of the first ball is smaller than the diameter of the second ball. In a preferred embodiment of the invention the balls are made from synthetic material or rubber. According to again another embodiment of the invention, the shutting off means of the inlet opening of the auxiliary reservoir comprise an inlet valve which is designed as a controllable shut-off valve. According to a further inventive feature, the controllable shut-off valve is suitable for operating under the control of a milk level sensor, such as e.g. a milk conductivity sensor or an optical or an acoustic sensor. According to a further inventive feature, the sensor is disposed in the auxiliary reservoir. According to again another aspect of the invention, the outlet valve of the shutting off means of the outlet opening of the auxiliary reservoir is designed as a further controllable shut-off valve. According to a further inventive feature, the further controllable shut-off valve is computer-controlled. To prevent the milk streaming out of the auxiliary reservoir from constantly arriving on the ground and flowing away, the auxiliary reservoir has an outflow opening that debouches into a collecting element. In other words, the milk, and in particular the foremilk, is collected in a special collecting element. The (fore)milk collected herein after one or more milkings may be further utilized; this also holds for the rinsing liquid collected in the auxiliary reservoir, in particular when it does not contain chemical components that are harmful to the animals, but substantially only consists of water with milk residues that may be present therein. For that purpose, according to the invention, the foremilk separated by means of the auxiliary reservoir and/or, when the relevant teat cup would be included in a rinsing line system, the rinsing fluid discharged via the auxiliary reservoir are/is conveyed to an implement for supplying fodder and/or drink to an animal. In this manner, neither the milk collected in the auxiliary reservoir, in particular the foremilk, nor—as far as water has been used as a rinsing liquid—the water with milk residues that may be present therein which flows out of the auxiliary reservoir, needs to be wasted.

The invention will now be explained in further detail with reference to the accompanying drawing in which

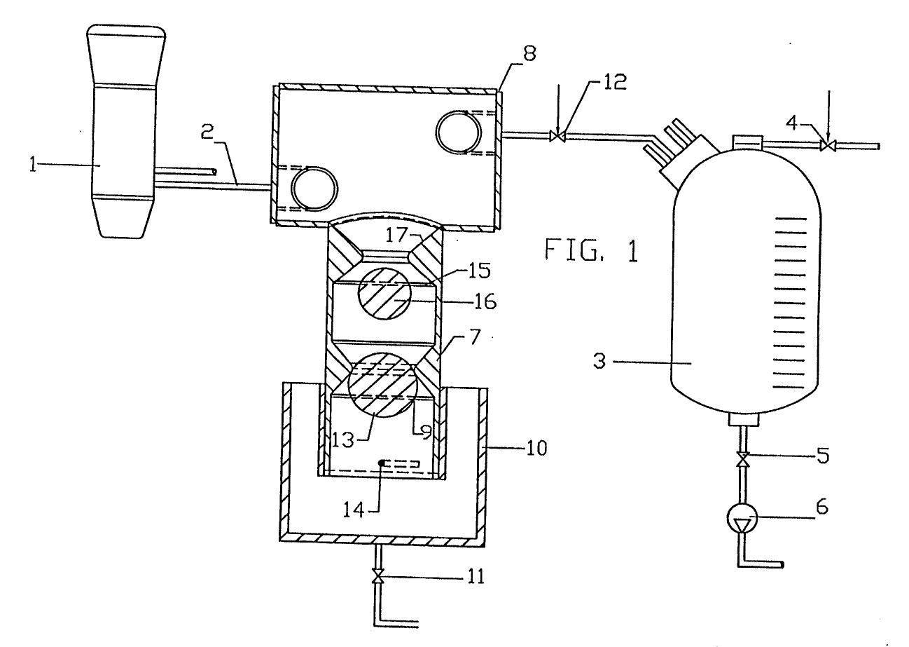

FIG. 1 shows schematically the milk line system between a milk glass and the milk container means.

Of the teat cups to be attached automatically to the teats of an animal to be milked by means of a (non-shown) milking robot, only one teat cup 1 is shown in FIG. 1. Like the other teat cups, said teat cup 1 is connected to milk collecting means 3 via a milk line 2. In the embodiment shown in this figure the milk collecting means are constituted by a milk glass. Into said milk glass 3 debouch the four milk lines 2 coming from the teat cups, while the milk glass is further connected via a valve 4 to the vacuum system of the milking implement. Via a valve 5 and by means of a pump 6, the milk is discharged from the milk glass 3 to a (non-shown) milk tank. In each of the milk lines 2 there is included an auxiliary reservoir 7. In FIG. 1 said provision is only depicted for one milk line. The content of the auxiliary reservoir is larger than the to be expected quantity of foremilk which is obtained via the relevant teat cup 1 at the beginning of the milking process. Preferably the content of the auxiliary reservoir is approximately two to three times as large as the to be expected quantity of foremilk. Via a connecting element 8 the auxiliary reservoir 7 is in open connection with the relevant milk line 2. The connecting element 8 is constituted by a space to which the interrupted ends of a milk line 2 are connected. In the bottom of said space there is provided an aperture which is in direct connection with the auxiliary reservoir 7. As shown in FIG. 2, the two ends of the milk line 2 are connected to the connecting element 8 in a substantially horizontal plane, in a staggered position opposite each other. Between the connecting element 8 and the milk glass 3 there is disposed a valve 12.

The auxiliary reservoir 7 is provided with an outlet valve 9, constituted by shutting off means, which is designed as a first ball that shuts off the auxiliary reservoir 7 by means of the vacuum present in a milk line 2. When the valve 12 is shut off and the vacuum in the milk line 2 is removed, then the auxiliary reservoir 7 is no longer shut off by the outlet valve 9. To prevent the first ball 13 from falling out of the outlet opening of the auxiliary reservoir 7, the outlet opening is blocked by means of a pin 14. Because of the pressure of the (fore)milk present in the auxiliary reservoir 7 the outlet valve 9 can easily give way and the (fore)milk flows into a collecting element 10. The (fore)milk collected in the collecting element 10 can be discharged via the valve 11 and a (non-shown) pump, in particular to an implement for supplying fodder and/or drink to an animal.

The milk obtained by means of the teat cups will not flow directly to the milk collecting means 3 because of the presence of the connecting element 8 in the milk line 2 and the aperture provided at the lower side thereof, said aperture being in connection with the auxiliary reservoir 7, as a result of the fact that the connecting element forms a resistance to the milk flow. Said resistance is realized by the staggered interruption, located in a substantially horizontal plane, in the milk line 2. Therefore, the first milk obtained will fill in the first instance the auxiliary reservoir 7 via the inlet opening at the lower side of the connecting element. In the auxiliary reservoir 7 there are provided further shutting off means 15 that shut off the auxiliary reservoir as soon as the latter is filled with the foremilk. The further shutting off means 15 comprise a float which is designed as a second ball 16 in the present embodiment. After the auxiliary reservoir 7 has been filled, the second bail 16 comes against a seat 17 so that the auxiliary reservoir 7 is shut off and the subsequent milk flow will stream via the connecting element 8 to the milk glass 3.

It has appeared in practice that the milk streaming from the teat cup 1 to the milk glass 3 does hardly mix, if at all, with the foremilk which is present in the lower part of the auxiliary reservoir.

When only the teat cups have to be cleaned, the teat cups are attached in the usual manner to rinsing members, with the aid of which a rinsing liquid is led into the teat cups and, if desired, also beyond the edge thereof. By closing the valve 12 provided behind the connecting element 8, said rinsing liquid can directly be discharged via the auxiliary reservoir 7; in that situation the valve 11 will in principle be opened. In this manner a very short discharge of rinsing liquid is possible, so that the teat cups can be cleaned easily, i.e. after each milking of an animal. In the same way drying air can be pressed through the teat cups and escape via the auxiliary reservoir 7. When the teat cups and also the milk line system have to be cleaned, the teat cups are again attached in the usual manner to rinsing members and are now also included in a rinsing line system. The rinsing liquid, like the (fore)milk, will fill in the first instance the auxiliary reservoir 7, and be led subsequently via the valve 12 further to the milk glass 3 and be discharged via the valve 5 and the pump 6. In this manner the teat cups and the lines connected thereto, the milk glass 3 included, are rinsed. When cleaning of the teat cups and the milk line system has been ended, rinsing liquid will remain in the auxiliary reservoir 7. When the rinsing members are detached from the teat cups and the teat cups are consequently again in open connection with the outside air, so that the vacuum is removed from the milk line 2, in the same manner as described in the foregoing for the (fore)milk present in the auxiliary reservoir, the rinsing liquid will arrive via the outlet valve 9 in the collecting element 10, while it can be discharged via the valve 11. In that situation the valve 12 is closed. When it has been ensured that the rinsing liquid does not contain chemical components that are harmful to the animals, and thus only consists of water with milk residues that may be present therein, the rinsing liquid collected in the collecting element 10 can also be conveyed as drinking-water to the implement for supplying fodder and/or drink to the animals.

1. An implement for milking animals, such as cows, provided with a milking parlour with a milking robot for automatically attaching teat cups (1) to the teats of an animal to be milked, said implement further being provided with milk container means for the milk obtained, while in at least one milk line (2) between the teat cups (1) and the milk container means there is provided an auxiliary reservoir (7) in which a certain quantity of milk, substantially obtained at the beginning of the milking process, is collected via an inlet opening and can leave said auxiliary reservoir (7) via an outlet opening with shutting off means (9), while the milk obtained thereafter is substantially led to the milk container means, characterized in that the inlet opening is provided with further shutting off means (13) which are at least suitable for preventing the milk collected in the auxiliary reservoir (7) from being discharged to the milk container means.

2. An implement as claimed in claim 1, characterized in that there is provided an auxiliary reservoir (7) in each of the milk lines (2) between a teat cup and the milk container means.

3. An implement as claimed in claim 1 or 2, characterized in that the content of the auxiliary reservoir (7) is larger than the to be expected quantity of foremilk.

4. An implement as claimed in claim 3, characterized in that the content of the auxiliary reservoir (7) is approximately two to three times as large as the to be expected quantity of foremilk.

5. An implement as claimed in any one of the preceding claims, characterized in that only at the beginning of the milking process the auxiliary reservoir (7) is in open connection with the relevant milk line (2) between a teat cup (1) and the milk container means.

6. An implement as claimed in claim 5, characterized in that in the relevant milk line (2) there is included a connecting element (8) to which the interrupted ends of the milk line (2) are connected, the lower side of said connecting element (8) being provided with an aperture to which the auxiliary reservoir (7) is connected.

7. An implement as claimed in claim 6, characterized in that the two ends of the milk lines (2) are connected to the connecting element (8) in a substantially horizontal plane, in a staggered position opposite each other.

8. An implement as claimed in any one of the preceding claims, characterized in that the shutting off means (9) comprise an outlet valve (12) that shuts off the auxiliary reservoir (7) by means of the vacuum present in the milk line (2).

9. An implement as claimed in claim 8, characterized in that the outlet valve (12) releases the outflow opening of the auxiliary reservoir (7) when after milking the teat cup (1) comes in open connection with the outside air, or when the teat cup (1) is included in a rinsing line system for only cleaning the teat cup (1) or when the teat cup (1) is included in a rinsing line system and rinsing of the teat cup (1) and the milk line system connected thereto is ended.

10. An implement as claimed in claim 8 or 9, characterized in that the outlet valve (9) is constituted by a first ball (13).

11. An implement as claimed in any one of the preceding claims, characterized in that the further shutting off means (15) of the inlet opening of the auxiliary reservoir (7) comprise an inlet valve (16) which is designed as a float.

12. An implement as claimed in claim 11, characterized in that the float is designed as a second ball (16).

13. An implement as claimed in any one of claims 10 to 12, characterized in that the diameter of the first ball (13) is smaller than the diameter of the second ball (16).

14. An implement as claimed in any one of claims 10 to 13, characterized in that the balls (13; 16) are made from synthetic material or rubber.

15. An implement as claimed in any one of claims 1 to 10, characterized in that the further shutting off means (15) of the inlet opening of the auxiliary reservoir (7) comprise an inlet valve which is designed as a controllable shut-off valve.

16. An implement as claimed in claim 15, characterized in that the controllable shut-off valve is suitable for operating under the control of a milk level sensor, such as e.g. a milk conductivity sensor or an optical or an acoustic sensor.

17. An implement as claimed in claim 16, characterized in that the sensor is disposed in the auxiliary reservoir.

18. An implement as claimed in any one of claims 1 to 9 or 11 to 17, characterized in that the outlet valve of the shutting off means (9) of the inlet opening of the auxiliary reservoir (7) is designed as a further controllable shut-off valve.

19. An implement as claimed in claim 18, characterized in that the further controllable shut-off valve is computer-controlled.

20. An implement as claimed in any one of the preceding claims, characterized in that the auxiliary reservoir (7) has an outflow opening that debouches into a collecting element (10).

21. An implement as claimed in claim 20, characterized in that the foremilk separated by means of the auxiliary reservoir (7) and/or, when the relevant teat cup (1) would be included in a rinsing line system, the rinsing liquid discharged via the auxiliary reservoir (7) can be conveyed to an implement for supplying fodder and/or drink to an animal.
